(19) United States
(12) Patent Application Publication
(10) Pub. No.: US 2025/0154869 A1
(43) Pub. Date: May 15, 2025

(54) TAILORING ROTOR BLADE SECTOR CONFIGURATIONS TO TUNE GAS TURBINE ENGINE BLADED ROTOR

(71) Applicant: Pratt & Whitney Canada Corp., Longueuil, Quebec (CA)

(72) Inventors: Yashiva Dorsamy, St Hubert, Quebec (CA); Philippe Boyer, Saint Isidore, Quebec (CA); Jasrobin Grewal, Pincourt, Quebec (CA); Prakul Mittal, Longueuil, Quebec (CA); Domenico Di Florio, Saint Lazare, Quebec (CA)

(21) Appl. No.: 18/388,285

(22) Filed: Nov. 9, 2023

(51) Int. Cl. F01D 5/14; F01D 5/06

(52) U.S. Cl. CPC F01D 5/02; F02C 3/02

(57) ABSTRACT

An apparatus is provided for a gas turbine engine. This apparatus includes a bladed rotor rotatable about an axis. The bladed rotor includes a rotor disk and a plurality of rotor blades projecting radially out from the rotor disk. The bladed rotor are divided into a plurality of circumferential sectors about the axis. Each of the circumferential sectors have a common circumferential length about the axis. Each of the circumferential sectors includes a subset of two or more of the rotor blades. The circumferential sectors include a first sector and a second sector. The first sector has a first rotor configuration. The second sector has a second rotor configuration that is different than the first rotor configuration.

### TECHNICAL FIELD

This disclosure relates generally to a gas turbine engine and, more particularly, to a bladed rotor for the gas turbine engine.

### BACKGROUND INFORMATION

A gas turbine engine includes multiple bladed rotors. Various types and configurations of bladed rotors are known in the art, including integrally bladed rotors (IBRs). While these known bladed rotors have various benefits, there is still room in the art for improvement.

### SUMMARY

According to an aspect of the present disclosure, an apparatus is provided for a gas turbine engine. This apparatus includes a bladed rotor rotatable about an axis. The bladed rotor includes a rotor disk and a plurality of rotor blades projecting radially out from the rotor disk. The bladed rotor are divided into a plurality of circumferential sectors about the axis. Each of the circumferential sectors have a common circumferential length about the axis. Each of the circumferential sectors includes a subset of two or more of the rotor blades. The circumferential sectors include a first sector and a second sector. The first sector has a first rotor configuration. The second sector has a second rotor configuration that is different than the first rotor configuration.

According to another aspect of the present disclosure, another apparatus is provided for a gas turbine engine. This apparatus includes a bladed rotor is rotatable about an axis. The bladed rotor includes a rotor disk and a plurality of rotor blades arranged circumferentially around and connected to the rotor disk. The bladed rotor is configured into a plurality of circumferential sectors about the axis. Each of the circumferential sectors includes a common number of the rotor blades that is greater than one. The circumferential sectors include a first sector and a second sector. The first sector has a first rotor mass and a first rotor geometry. The second sector has a second rotor mass and a second rotor geometry. The second rotor mass is different than the first rotor mass, and/or the second rotor geometry is different than the first rotor geometry.

According to still another aspect of the present disclosure, another apparatus is provided for a gas turbine engine. This apparatus includes a bladed rotor rotatable about an axis. The bladed rotor includes a rotor disk and a plurality of rotor blades arranged circumferentially around and connected to the rotor disk. The bladed rotor has a plurality of circumferential sectors about the axis. Each of the circumferential sectors has a common circumferential length about the axis. The circumferential sectors include a first sector and a second sector. A section of the rotor disk is defined by the first sector having a first disk mass and a first disk geometry. A section of the rotor disk is defined by the second sector having a second disk mass and a second disk geometry. The second disk mass is different than the first disk mass and/or the second disk geometry is different than the first disk geometry.

A section of the rotor disk defined by the first sector may have a first disk mass and a first disk geometry. A section of the rotor disk defined by the second sector may have a second disk mass and a second disk geometry. The second disk mass may be different than the first disk mass and/or the second disk geometry may be different than the first disk geometry.

A first of the rotor blades included in the first sector may have a first blade mass and a first blade geometry. A second of the rotor blades included in the second sector may have a second blade mass and a second blade geometry. The second blade mass may be different than the first blade mass and/or the second blade geometry may be different than the first blade geometry.

The first sector may be one of a plurality of first sectors. The second sector may be one of a plurality of second sectors. The second sectors may be interspersed with the first sectors about the axis in a repeating pattern.

The first sector may have a first mass. The second sector may have a second mass that is different than the first mass.

The bladed rotor in each of the circumferential sectors may have a dimension at a reference location. The dimension of the bladed rotor in the first sector may be different than the dimension of the bladed rotor in the second sector.

The bladed rotor in each of the circumferential sectors may have a geometry. The geometry of the bladed rotor in the first sector may be different than the geometry of the bladed rotor in the second sector.

A section of the rotor disk defined by the first sector may have a first disk configuration. A section of the rotor disk defined by the second sector may have a second disk configuration that is different than the first disk configuration.

The section of the rotor disk defined by the first sector may have a first mass. The section of the rotor disk defined by the second sector may have a second mass that is different than the first mass.

The section of the rotor disk defined by the first sector may have a first geometry. The section of the rotor disk defined by the second sector may have a second geometry that is different than the first geometry.

Each of the rotor blades may have a common blade configuration.

A rotor blade in the subset of the two or more of the rotor blades in the first sector may have a first blade configuration. A rotor blade in the subset of the two or more of the rotor blades in the second sector may have a second blade configuration that is different than the first blade configuration.

Each rotor blade in the subset of the two or more of the rotor blades in the first sector may have a first blade configuration. Each rotor blade in the subset of the two or more of the rotor blades in the second sector may have a second blade configuration that is different than the first blade configuration.

Each rotor blade in the subset of the two or more of the rotor blades in the first sector may have a first mass. Each rotor blade in the subset of the two or more of the rotor blades in the second sector may have a second mass that is different than the first mass.

Each rotor blade in the subset of the two or more of the rotor blades in the first sector may have a first geometry. Each rotor blade in the subset of the two or more of the rotor blades in the second sector may have a second geometry that is different than the first geometry.

The subset of the two or more of the rotor blades in the first sector may only include N1 number of the rotor blades. The subset of the two or more of the rotor blades in the second sector may only include N2 number of the rotor blades. The N2 number may be equal to the N1 number.

The bladed rotor may be divided into a number of the circumferential sectors about the axis. The number may be an even integer between two and sixteen.

The first sector may be disposed circumferentially adjacent the second sector.

The bladed rotor may be configured as a turbine rotor for the gas turbine engine.

The apparatus may also include a compressor section, a combustor section, a turbine section and a flowpath extending through the compressor section, the combustor section and the turbine section from an inlet into the flowpath to an exhaust from the flowpath. The turbine section may include the bladed rotor.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a partial side schematic illustration of a powerplant for an aircraft.

FIG. 2 is a schematic illustration of an integrally bladed rotor.

FIG. 3 is a partial side sectional schematic illustration of the bladed rotor.

FIG. 4 is a side schematic illustration of a portion of the bladed rotor.

FIG. 5 is a cross-sectional schematic illustration of a rotor blade along line 5-5 in FIG. 4.

FIG. 6 is a side sectional illustration of the bladed rotor at a first sector.

FIG. 7 is a side sectional illustration of the bladed rotor at a second sector.

FIG. 8 is a side sectional illustration of the bladed rotor at the second sector with alternative arrangement of protrusions.

FIG. 9 is a partial schematic illustration of an upstream side of the bladed rotor.

FIG. 10 is a partial schematic illustration of a downstream side of the bladed rotor.

FIG. 11 is a partial perspective illustration of the bladed rotor with different rotor blade configurations in the first and the second sectors.

### DETAILED DESCRIPTION

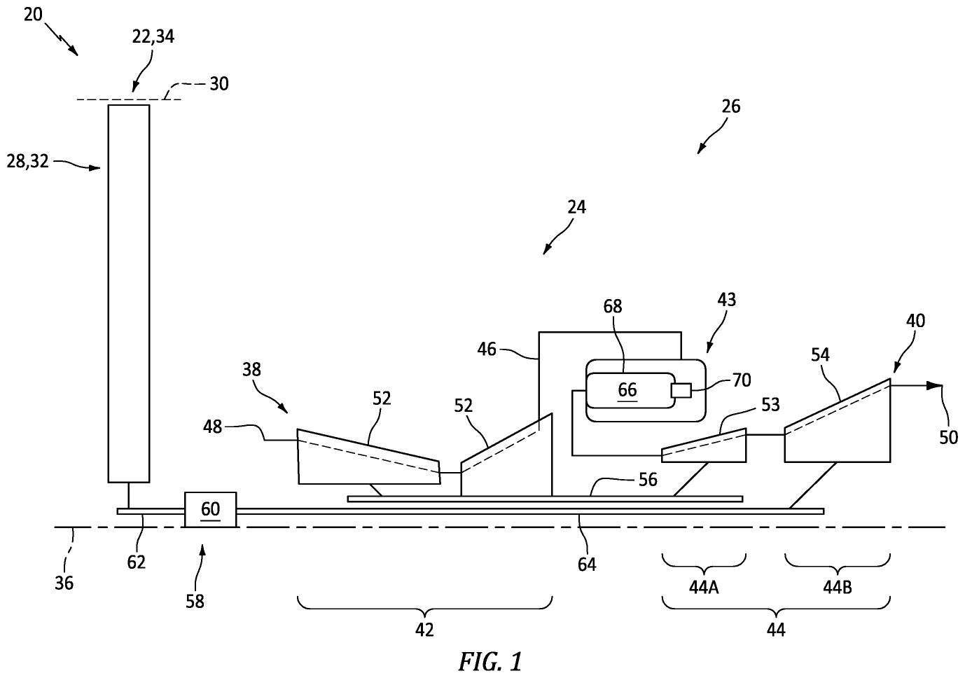

FIG. 1 illustrates a powerplant 20 for an aircraft. The aircraft may be an airplane, a helicopter, a drone (e.g., an unmanned aerial vehicle (UAV)) or any other manned or unmanned aerial vehicle or system. The powerplant 20 may be configured as, or otherwise included as part of, a propulsion system for the aircraft. The powerplant 20 may also or alternatively be configured as, or otherwise included as part of, an electrical power system for the aircraft. The powerplant 20 of the present application, however, is not limited to aircraft applications. The powerplant 20, for example, may alternatively be configured as, or otherwise included as part of, an industrial gas turbine engine for a land-based electrical powerplant. The powerplant 20 of FIG. 1 includes a mechanical load 22 and a core 24 of a gas turbine engine 26.

The mechanical load 22 may be configured as or otherwise include a rotor 28 mechanically driven and/or otherwise powered by the engine core 24. This driven rotor 28 may be a bladed propulsor rotor (e.g., an air mover) where the powerplant 20 is (or is part of) the aircraft propulsion system. The propulsor rotor may be an open (e.g., un-ducted) propulsor rotor or a ducted propulsor rotor housed within a duct 30; e.g., a fan duct. Examples of the open propulsor rotor include a propeller rotor for a turboprop gas turbine engine, a rotorcraft rotor (e.g., a main helicopter rotor) for a turboshaft gas turbine engine, a propfan rotor for a propfan gas turbine engine, and a pusher fan rotor for a pusher fan gas turbine engine. An example of the ducted propulsor rotor is a fan rotor 32 for a turbofan gas turbine engine. The present disclosure, however, is not limited to the foregoing exemplary propulsor rotor arrangements. Moreover, the driven rotor 28 may alternatively be a generator rotor of an electric power generator where the powerplant 20 is (or is part of) the aircraft power system; e.g., an auxiliary power unit (APU) for the aircraft. However, for ease of description, the mechanical load 22 is described below as a fan section 34 of the gas turbine engine 26, and the driven rotor 28 is described below as the fan rotor 32 within the fan section 34.

The gas turbine engine 26 extends axially along an axis 36 between and to an upstream end of the gas turbine engine 26 and a downstream end of the gas turbine engine 26. This axis 36 may be a centerline axis of any one or more of the powerplant members 24, 26 and 28. The axis 36 may also or alternatively be a rotational axis of one or more rotating assemblies (e.g., 38 and 40) of the gas turbine engine 26 and its engine core 24.

The engine core 24 includes a compressor section 42, a combustor section 43, a turbine section 44 and a core flowpath 46. The turbine section 44 includes a high pressure turbine (HPT) section 44A and a low pressure turbine (LPT) section 44B; e.g., a power turbine (PT) section. The core flowpath 46 extends sequentially through the compressor section 42, the combustor section 43, the HPT section 44A and the LPT section 44B from an airflow inlet 48 into the core flowpath 46 to a combustion products exhaust 50 from the core flowpath 46. The core inlet 48 of FIG. 1 is disposed towards the engine upstream end, downstream of the fan section 34 and its fan rotor 32. The core exhaust 50 of FIG. 1 is disposed at (e.g., on, adjacent or proximate) or otherwise towards the engine downstream end.

Each of the engine sections 42, 44A and 44B includes one or more respective bladed rotors 52-54. The compressor rotors 52 are coupled to and rotatable with the HPT rotor 53. The compressor rotors 52 of FIG. 1, for example, are connected to the HPT rotor 53 by a high speed shaft 56. At least (or only) the compressor rotors 52, the HPT rotor 53 and the high speed shaft 56 collectively form the high speed rotating assembly 38; e.g., a high speed spool. The fan rotor 32 is coupled to and rotatable with the LPT rotor 54. The fan rotor 32 of FIG. 1, for example, is connected to the LPT rotor 54 by a drivetrain 58. This drivetrain 58 may be configured as a geared drivetrain. The fan rotor 32 of FIG. 1, for example, is connected to a geartrain 60 by a fan shaft 62, where the geartrain 60 may be an epicyclic geartrain or another type of gear system and/or transmission. The geartrain 60 is connected to the LPT rotor 54 through a low speed shaft 64. With this arrangement, the LPT rotor 54 may rotate at a different (e.g., faster) speed than the fan rotor 32 (the driven rotor 28). At least (or only) the fan rotor 32, the LPT rotor 54, the engine shafts 62 and 64 and the geartrain 60 collectively form the low speed rotating assembly 40. In other embodiments, however, the drivetrain 58 may alternatively be configured as a direct drive system where the geartrain 60 is omitted and the LPT rotor 54 and the fan rotor 32 (the driven rotor 28) rotate at a common (the same) speed. Referring again to FIG. 1, each of the rotating assemblies 38 and 40 and its members may be rotatable about the axis 36.

During operation of the powerplant 20 and its gas turbine engine 26, air may be directed across the fan rotor 32 and into the engine core 24 through the core inlet 48. This air entering the core flowpath 46 may be referred to as “core air”. The core air is compressed by the compressor rotors 52 and directed into a combustion chamber 66 (e.g., an annular combustion chamber) within a combustor 68 (e.g., an annular combustor) of the combustor section 43. Fuel is injected into the combustion chamber 66 by one or more fuel injectors 70 and mixed with the compressed core air to provide a fuel-air mixture. This fuel-air mixture is ignited and combustion products thereof flow through and sequentially cause the HPT rotor 53 and the LPT rotor 54 to rotate. The rotation of the HPT rotor 53 drives rotation of the compressor rotors 52 and, thus, the compression of the air received from the core inlet 48. The rotation of the LPT rotor 54 drives rotation of the fan rotor 32 (the driven rotor 28). Where the driven rotor 28 is configured as the propulsor rotor, the rotation of that propulsor rotor may propel additional air (e.g., outside air, bypass air, etc.) outside of the engine core 24 to provide aircraft thrust and/or lift. The rotation of the fan rotor 32, for example, propels bypass air through a bypass flowpath outside of the engine core 24 to provide aircraft thrust. However, where the driven rotor 28 is configured as the generator rotor, the rotation of that generator rotor may facilitate generation of electricity.

For ease of description, the gas turbine engine 26 is described above with an exemplary arrangement of engine sections 34, 42, 43, 44A and 44B and an exemplary arrangement of rotating assemblies 38 and 40. The present disclosure, however, is not limited to such exemplary arrangements. The compressor section 42, for example, may include a low pressure compressor (LPC) section and a high pressure compressor (HPC) section, where one or more of the compressor rotors 52 may be disposed in the HPC section and the LPC section may include a low pressure compressor (LPC) rotor coupled to the LPT rotor 54 through the low speed shaft 64. In another example, the gas turbine engine 26 and its engine core 24 may include a single rotating assembly (e.g., spool), or more than two rotating assemblies (e.g., spools).

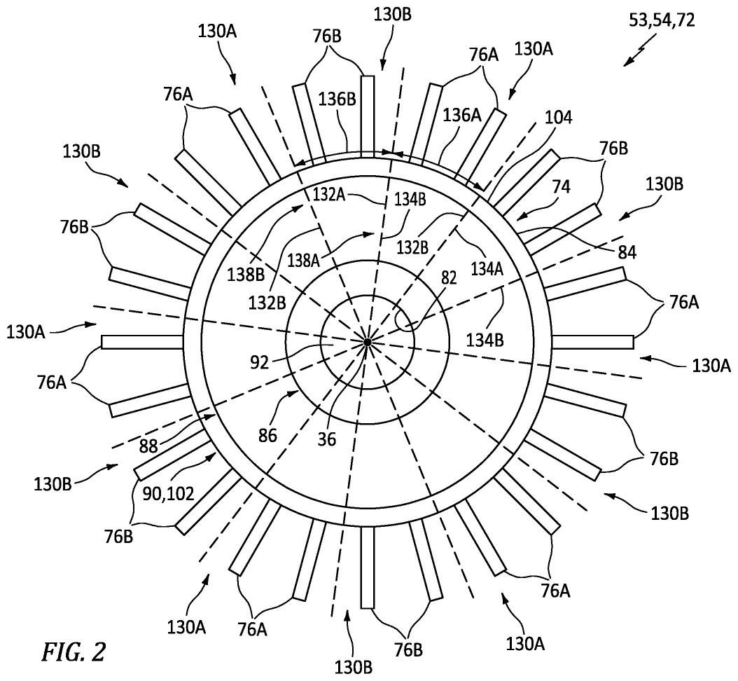

FIG. 2 schematically illustrates an integrally bladed rotor (IBR) 72 for the gas turbine engine 26 and its engine core 24 (see FIG. 1). The bladed rotor 72 may be configured as the HPT rotor 53 or the LPT rotor 54. However, it is contemplated these teachings may also be applied to one or more of the compressor rotors 52; see FIG. 1. The bladed rotor 72 is rotatable about the axis 36. This bladed rotor 72 includes a rotor disk 74 (e.g., a turbine disk) and a plurality of rotor blades 76A and 76B (generally referred to as “76”) (e.g., turbine blades).

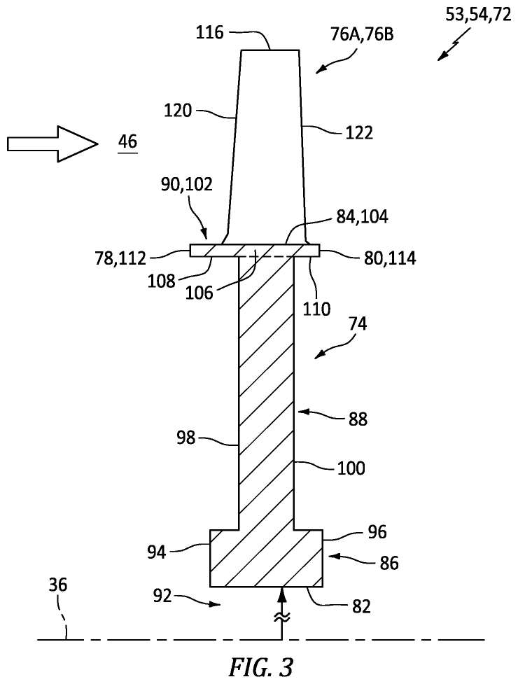

Referring to FIG. 3, the rotor disk 74 extends axially along the axis 36 between and to an axial upstream side 78 of the bladed rotor 72 and its rotor disk 74 and an axial downstream side 80 of the bladed rotor 72 and its rotor disk 74. Here, the rotor upstream side 78 is upstream of the rotor downstream side 80 along the core flowpath 46. The rotor disk 74 extends radially from a radial inner side 82 of the bladed rotor 72 and its rotor disk 74 to a radial outer side 84 of the rotor disk 74. Referring to FIG. 2, the rotor disk 74 extends circumferentially about the axis 36 providing the rotor disk 74 with a full-hoop (e.g., annular) geometry. The rotor disk 74 includes an annular disk hub 86, an annular disk web 88 and an annular disk rim 90.

Referring to FIG. 3, the disk hub 86 may form an inner mass of the rotor disk 74. The disk hub 86 is disposed at the rotor inner side 82 and forms a radial inner periphery of the bladed rotor 72 and its rotor disk 74. The disk hub 86 of FIG. 3 thereby forms and circumscribes an inner bore 92 of the bladed rotor 72, which inner bore 92 extends axially along the axis 36 through the bladed rotor 72 and its rotor disk 74. The disk hub 86 extends axially along the axis 36 between and to opposing axial sides 94 and 96 of the disk hub 86.

The disk web 88 is radially between and connects the disk hub 86 and the disk rim 90. The disk web 88 of FIG. 3, for example, projects radially out from (in an outward direction away from the axis 36) the disk hub 86 to the disk rim 90. This disk web 88 is formed integral with the disk hub 86 and the disk rim 90. The disk web 88 extends axially along the axis 36 between and to opposing axial sides 98 and 100 of the disk web 88. The web upstream side 98 may be axially recessed from the hub upstream side 94. The web downstream side 100 may be axially recessed from the hub downstream side 96. An axial width of the disk web 88 may thereby be different (e.g., thinner) than an axial width of the disk hub 86. The present disclosure, however, is not limited to such an exemplary arrangement.

The disk rim 90 is disposed at the disk outer side 84 and forms a radial outer periphery of the rotor disk 74. This disk rim 90 of FIG. 3 also forms a radial inner platform 102 of the bladed rotor 72. A radial outer surface 104 of the inner platform 102 forms an inner peripheral boundary of the core flowpath 46 (e.g., axially in FIG. 3) across the bladed rotor 72.

The disk rim 90 of FIG. 3 includes a rim base 106, an axial upstream flange 108 and an axial downstream flange 110. The rim base 106 is axially aligned with and radially outboard of the disk web 88. This rim base 106 connects the upstream flange 108 and the downstream flange 110 to the disk web 88. The upstream flange 108 projects axially along the axis 36 (in an upstream direction along the core flowpath 46) out from the rim base 106 and the disk web 88 to an axial distal end 112 of the upstream flange 108 at the rotor upstream side 78. The downstream flange 110 projects axially along the axis 36 (in a downstream direction along the core flowpath 46) out from the rim base 106 and the disk web 88 to an axial distal end 114 of the downstream flange 110 at the rotor downstream side 80. With this arrangement, the rim members 106, 108 and 110 collectively form the inner platform 102 and its platform outer surface 104. More particularly, the upstream flange 108 forms an axial upstream section of the platform outer surface 104. The downstream flange 110 forms an axial downstream section of the platform outer surface 104. The rim base 106 forms an axial intermediate section of the platform outer surface 104 extending axially between the upstream section of the platform outer surface 104 and the downstream section of the platform outer surface 104.

Referring to FIG. 2, the rotor blades 76 are arranged circumferentially (e.g., equispaced) around the axis 36 in an annular array; e.g., a circular array. This array of rotor blades 76 is disposed radially outboard of and circumscribes the rotor disk 74 and its inner platform 102. Each of the rotor blades 76 is formed integral with the rotor disk 74. The bladed rotor 72, more particularly, is formed as a single unitary body. Here, the term “unitary” may describe a body without severable parts. By contrast, a traditional bladed rotor includes rotor blades which are mechanically attached to a rotor disk through, for example, dovetail interfaces, firtree interfaces or other removable attachments.

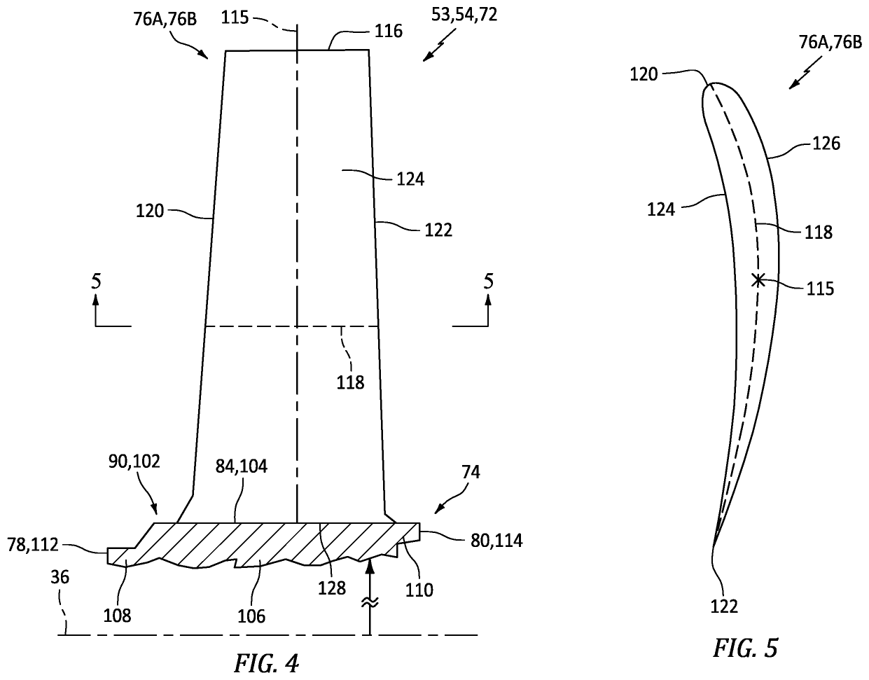

Referring to FIG. 4, each rotor blade 76 projects radially (e.g., spanwise along a span line 115 of the respective rotor blade 76) out from the rotor disk 74 and its platform outer surface 104 to a tip 116 of the respective rotor blade 76. Each rotor blade 76 extends longitudinally along a camber line 118 of the respective rotor blade 76 from a leading edge 120 of the respective rotor blade 76 to a trailing edge 122 of the respective rotor blade 76. Referring to FIG. 5, each rotor blade 76 extend laterally (e.g., in a direction perpendicular to the camber line 118) between and to a lateral first side 124 (e.g., a concave, pressure side) of the respective rotor blade 76 and a lateral second side 126 (e.g., a convex, suction side) of the respective rotor blade 76. These opposing lateral sides 124 and 126 extend longitudinally along the camber line 118 and meet at the leading edge 120 and the trailing edge 122. Referring to FIG. 4, each rotor element 120, 122, 124 and 126 (element 126 not visible in FIG. 4) may extend radially out from a base 128 of the respective rotor blade 76 at the inner platform 102 and its platform outer surface 104 to the blade tip 116.

Referring to FIG. 2, the bladed rotor 72 is divided into a plurality of circumferential sectors 130A and 130B (generally referred to as “130”) about the axis 36. Each of these rotor sectors 130 extends circumferentially about the axis 36 between a circumferential first side 132A, 132B (generally referred to as “132”) of the respective rotor sector 130 and a circumferential second side 134A, 134B (generally referred to as “134”) of the respective rotor sector 130. The first rotor sectors 130A are interspersed with the second rotor sectors 130B in a repeating pattern about the axis 36. Each first rotor sector 130A of FIG. 2, for example, is disposed circumferentially between and is next to a circumferentially neighboring pair of the second rotor sectors 130B. Similarly, each second rotor sector 130B of FIG. 2 is disposed circumferentially between and is next to a circumferentially neighboring pair of the first rotor sectors 130A. With this arrangement, the first side 132A of each first rotor sector 130A is adjacent the second side 134B of a respective one of the second rotor sectors 130B, and the second side 134A of each first rotor sector 130A is adjacent the first side 132B of a respective one of the second rotor sectors 130B. Similarly, the first side 132B of each second rotor sector 130B is adjacent the second side 134A of a respective one of the first rotor sectors 130A, and the second side 134B of each second rotor sector 130B is adjacent the first side 132A of a respective one of the first rotor sectors 130A.

Each of the first rotor sectors 130A has a common (the same) first circumferential length 136A about the axis 36. This first circumferential length 136A is measured between the opposing circumferential sides 132A and 134A of the respective first rotor sector 130A, for example at the outer periphery of the rotor disk 74; e.g., along the platform outer surface 104. Each of the second rotor sectors 130B has a common second circumferential length 136B about the axis 36. This second circumferential length 136B is measured between the opposing circumferential sides 132B and 134B of the respective second rotor sector 130B, for example at the outer periphery of the rotor disk 74; e.g., along the platform outer surface 104. The second circumferential length 136B of FIG. 2 is equal to the first circumferential length 136A of FIG. 2. The rotor sectors 130 of FIG. 2 thereby share/have a common circumferential length about the axis 36.

Each first rotor sector 130A includes a first disk section 138A of the rotor disk 74 and a subset of the first rotor blades 76A. The first disk section 138A extends circumferentially between the opposing circumferential sides 132A and 134A of the respective first rotor sector 130A. The first disk section 138A extends radially between the rotor inner side 82 and the disk outer side 84. The first disk section 138A extends axially along the axis 36 between the opposing axial rotor sides 78 and 80 (see FIG. 3). The first disk section 138A of FIG. 2 thereby includes an entire portion of the rotor disk 74 circumferentially between the opposing circumferential sides 132A and 134A of the respective first rotor sector 130A. The subset of the first rotor blades 76A includes the first rotor blade(s) 76A which are (e.g., completely) bounded by (e.g., straight) reference lines extending radially along the opposing circumferential sides 132A and 134A of the respective first rotor sector 130A. Alternatively, the subset of the first rotor blades 76A may include the first rotor blade(s) 76A with its leading edge 120 or its trailing edge 122 (see FIGS. 4 and 5) located between the reference lines. Each subset of the first rotor blades 76A of FIG. 2 includes two of the first rotor blades 76A; however, in other embodiments, each subset of the first rotor blades 76A may alternatively include a single one of the first rotor blades 76A or more than two of the first rotor blades 76A.

Each second rotor sector 130B includes a second disk section 138B of the rotor disk 74 and a subset of the second rotor blades 76B. The second disk section 138B extends circumferentially between the opposing circumferential sides 132B and 134B of the respective second rotor sector 130B. The second disk section 138B extends radially between the rotor inner side 82 and the disk outer side 84. The second disk section 138B extends axially along the axis 36 between the opposing axial rotor sides 78 and 80 (see FIG. 3). The second disk section 138B of FIG. 2 thereby includes an entire portion of the rotor disk 74 circumferentially between the opposing circumferential sides 132B and 134B of the respective second rotor sector 130B. The subset of the second rotor blades 76B includes the second rotor blade(s) 76B which are (e.g., completely) bounded by (e.g., straight) reference lines extending radially along the opposing circumferential sides 132B and 134B of the respective second rotor sector 130B. Alternatively, the subset of the second rotor blades 76B may include the second rotor blade(s) 76B with its leading edge 120 or its trailing edge 122 (see FIGS. 4 and 5) located between the reference lines. Each subset of the second rotor blades 76B of FIG. 2 includes two of the second rotor blades 76B; however, in other embodiments, each subset of the second rotor blades 76B may alternatively include a single one of the second rotor blades 76B or more than two of the second rotor blades 76B. However, a number N2 of the second rotor blades 76B included in each second rotor sector 130B may be equal to a number N1 of the first rotor blades 76A included in each first rotor sector 130A.

Each of the first rotor sectors 130A is provided with a common first configuration. Each of the first rotor sectors 130A, for example, is configured with a common first mass, a common first geometry (e.g., a three-dimensional (3D) exterior geometric shape), common first dimensions (e.g., widths, lengths, heights, thicknesses, etc.), common internal feature(s) (e.g., cooling circuits, etc.) when included, and various other common parameters. The first configuration and its parameters provide each first rotor sector 130A with certain static and dynamic properties. Similarly, each of the second rotor sectors 130B is provided with a common second configuration. Each of the second rotor sectors 130B, for example, is configured with a common second mass, a common second geometry (e.g., a three-dimensional (3D) exterior geometric shape), common second dimensions (e.g., widths, lengths, heights, thicknesses, etc.), common internal feature(s) (e.g., cooling circuits, etc.) when included, and various other common parameters. The second configuration and its parameters provide each second rotor sector 130B with certain static and dynamic properties.

While the first rotor sectors 130A share the same first configuration and the second rotor sectors 130B share the same second configuration, the first configuration and, thus, any one or more of its parameters is different than the second configuration and, thus, any one or more of its corresponding parameters. The differences are tailored to provide the first rotor sectors 130A and the second rotor sectors 130B with different static and dynamic properties; e.g., stiffnesses, center of mass locations, vibrational responses, etc. The first rotor sectors 130A and the second rotor sectors 130B may thereby be respectively configured to tune a dynamic response of the bladed rotor 72. The first rotor sectors 130A and the second rotor sectors 130B, for example, may be configured to reduce a vibratory response of the bladed rotor 72 during, for example, high speed rotation of the bladed rotor 72 about the axis 36. Fundamental bending modes of the bladed rotor 72 may be mistuned for low nodal diameter (ND) excitations; e.g., from a first nodal diameter (ND1) excitation to an eighth nodal diameter (ND8) excitation. These fundamental bending modes include:
Mode 1: Easy wise bending such as bending from pressure to suction side and vice versa;
Mode 2: Stiff wise bending such as bending from leading edge to trailing edge and vice versa; and
Mode 3: Torsional bending such as airfoil twisting about its stack line.

The bladed rotor 72 may be further tuned to target a specific nodal diameter. For example, a number M1 of the first rotor sectors 130A of FIG. 2 is equal to a number M2 of the second rotor sectors 130B. This number M1, M2 is an integer equal to or greater than one. The number M1, M2 may be selected to correspond to the targeted nodal diameter for vibration reduction. For example, the number M1, M2 of FIG. 2 is equal to six (6) to target sixth nodal diameter (ND6) excitation. Of course, the foregoing number M1, M2 and targeted nodal diameter is exemplary and the present disclosure is not limited thereto. For example, the bladed rotor 72 may alternatively be configured to target seventh or eighth nodal diameter (ND7 or ND8) excitation, where the number M1, M2 of rotor sectors is selected as seven (7) or eight (8), respectively. In another example, the bladed rotor 72 may be configured to target fourth or fifth nodal diameter (ND4 or ND5) excitation, where the number M1, M2 of rotor sectors is selected as four (4) or five (5), respectively.

To provide the first rotor sectors 130A and the second rotor sectors 130B with their different configurations, (A) the first disk sections 138A and the second disk sections 138B may be provided with different configurations and/or (B) the first rotor blades 76A and the second rotor blades 76B may be provided with different configurations. For example, one or more parameters of each first disk section 138A may be configured differently than one or more corresponding parameters of each second disk section 138B. Examples of the disk parameter(s) which may be different include, but are not limited to: a mass of the respective disk section 138A, 138B (generally referred to as “138”), a geometry (e.g., a three-dimensional (3D) exterior geometric shape) of the respective disk section 138, one or more dimensions (e.g., widths, lengths, heights, thicknesses, etc.) of the respective disk section 138, and a configuration of one or more internal feature(s) (e.g., cooling circuits, etc.) of the respective disk section 138 (when included). In another example, one or more parameters of each first rotor blade 76A may be configured differently than one or more corresponding parameters of each second rotor blade 76B. Examples of the blade parameter(s) which may be different include, but are not limited to: a mass of the respective rotor blade 76, a geometry (e.g., a three-dimensional (3D) exterior geometric shape) of the respective rotor blade 76, one or more dimensions (e.g., widths, lengths, heights, thicknesses, etc.) of the respective rotor blade 76, and a configuration of one or more internal feature(s) (e.g., cooling circuits, etc.) of the respective rotor blade 76 (when included).

In general, a primary manner for tuning (e.g., mistuning) the response of the bladed rotor 72 may be through providing the first disk sections 138A and the second disk sections 138B with different configurations. The first rotor blades 76A and the second rotor blades 76B may thereby be provided with a common configuration to facilitate ease of manufacture, rotor blade design, consistent aerodynamics within the flowpath 46, etc. However, where additional tuning is desirable, the first rotor blades 76A and the second rotor blades 76B may be provided with different configurations. However, it is contemplated the first rotor blades 76A and the second rotor blades 76B may alternatively be provided with different configurations and the first disk sections 138A, and the second disk sections 138B may be provided with a common configuration.

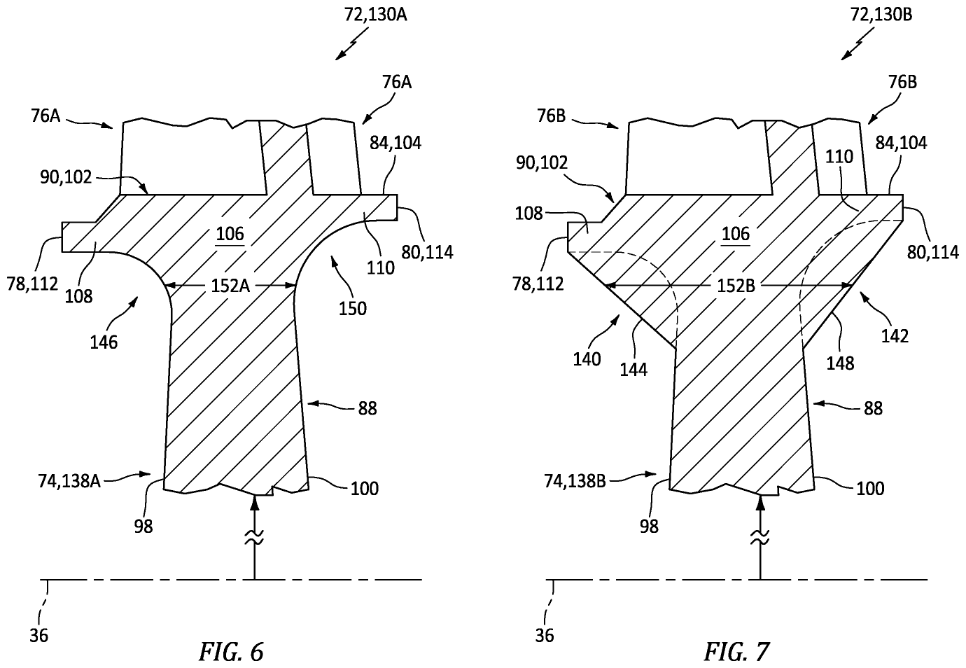

FIGS. 6 and 7 illustrate sections of the rotor disk 74 with different configurations. For ease of description, the first disk section 138A of FIG. 6 is described as having a baseline configuration, and the second disk section 138B of FIG. 7 is described as being modified to change its configuration relative to the first disk section 138A of FIG. 6. FIG. 7 therefore includes dashed lines projected onto the second disk section 138B to illustrate differences between each first disk section 138A and each second disk section 138B. As shown in FIG. 7, the second disk section 138B includes one or more protrusions 140 and 142. These protrusions 140 and 142 are included in addition to the baseline configuration of the first disk section 138A of FIG. 6; thus, the first disk section 138A of FIG. 6 is configured without the protrusions 140 and 142.

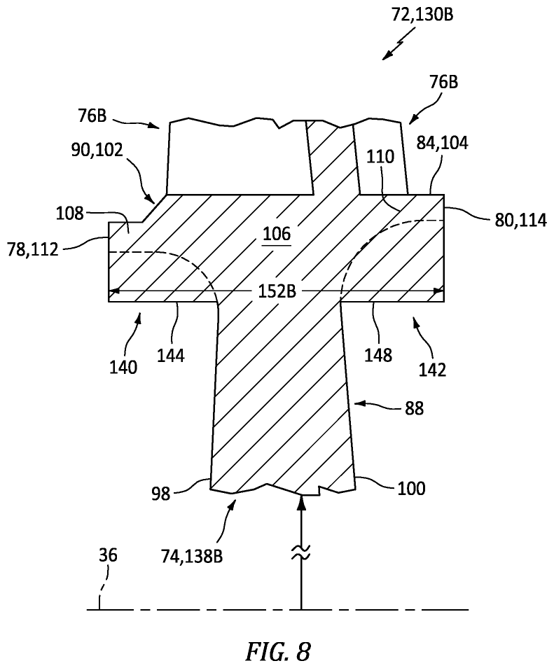

The upstream protrusion 140 may be configured as a fillet. The upstream protrusion 140 of FIG. 7, for example, extends diagonally (e.g., radially and axially) between the upstream flange 108 and the disk web 88. This upstream protrusion 140 has an (e.g., arcuate) inner surface 144 which extends from (or about) the upstream flange distal end 112 to the web upstream side 98. The upstream protrusion inner surface 144 of FIG. 7 is angularly offset from the axis 36 by an included angle. This included angle may be between thirty degrees and sixty degrees; e.g., forty-five degrees. At least a portion or an entirety of the upstream protrusion inner surface 144 may have a straight sectional geometry when viewed, for example, in a second rotor section reference plane parallel with (e.g., including) the axis 36; e.g., plane of FIG. 7. The present disclosure, however, is not limited to such an exemplary upstream protrusion arrangement. The upstream protrusion 140 of FIG. 8, for example, is configured as a castellation; e.g., a tooth. Here, the upstream protrusion inner surface 144 may be parallel with (or slightly angularly offset from) the axis 36.

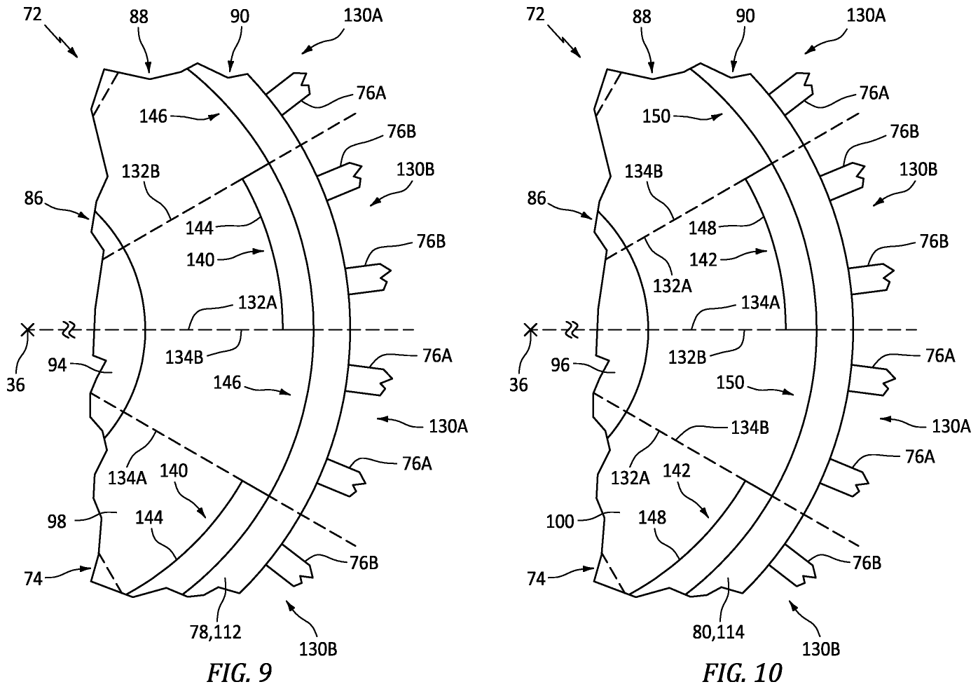

Referring to FIG. 9, each upstream protrusion 140 may extend (e.g., uniformly) circumferentially about the axis 36 between the opposing circumferential sides 132B and 134B of the respective second rotor sector 130B. With this arrangement, the bladed rotor 72 is provided with a plurality of upstream recesses 146; e.g., notches, grooves or other apertures. Each upstream recess 146 projects axially and radially into the bladed rotor 72 and its rotor disk 74. Each upstream recess 146 extends circumferentially within the bladed rotor 72 between opposing circumferential sides 132A and 134A of the respective first rotor sector 130A. In particular, each upstream recess 146 extends circumferentially within the bladed rotor 72 between a circumferentially neighboring pair of the upstream protrusions 140. The present disclosure, however, is not limited to such an exemplary upstream recess arrangement.

Referring to FIG. 7, the downstream protrusion 142 may be configured as a fillet. The downstream protrusion 142 of FIG. 7, for example, extends diagonally (e.g., radially and axially) between the downstream flange 110 and the disk web 88. This downstream protrusion 142 has an (e.g., arcuate) inner surface 148 which extends from (or about) the downstream flange distal end 114 to the web downstream side 100. The downstream protrusion inner surface 148 of FIG. 7 is angularly offset from the axis 36 by an included angle. This included angle may be between forty degrees and eight degrees; e.g., sixty degrees. At least a portion or an entirety of the downstream protrusion inner surface 148 may have a straight sectional geometry when viewed, for example, in the second rotor section reference plane. The present disclosure, however, is not limited to such an exemplary downstream protrusion arrangement. The downstream protrusion 142 of FIG. 8, for example, is configured as a castellation; e.g., a tooth. Here, the downstream protrusion inner surface 148 may be parallel with (or slightly angularly offset from) the axis 36.

Referring to FIG. 10, each downstream protrusion 142 may extend (e.g., uniformly) circumferentially about the axis 36 between the opposing circumferential sides 132B and 134B of the respective second rotor sector 130B. With this arrangement, the bladed rotor 72 is provided with a plurality of downstream recesses 150; e.g., notches, grooves or other apertures. Each downstream recess 150 projects axially and radially into the bladed rotor 72 and its rotor disk 74. Each downstream recess 150 extends circumferentially within the bladed rotor 72 between opposing circumferential sides 132A and 134A of the respective first rotor sector 130A. In particular, each downstream recess 150 extends circumferentially within the bladed rotor 72 between a circumferentially neighboring pair of the downstream protrusions 142. The present disclosure, however, is not limited to such an exemplary downstream recess arrangement.

With the arrangement of FIG. 7 or 8, at least one axial dimension 152A, 152B of the bladed rotor 72 and its rotor disk 74 (e.g., when measured at a common radial distance out from the axis 36) is different between the first disk section 138A (see FIG. 6) and the second disk section 138B (see FIG. 7 or 8). More particularly, the axial dimension 152B of the second disk section 138B of FIG. 7 or 8 is greater than the axial dimension 152A of the first disk section 138A of FIG. 6. A mass of the second disk section 138B of FIG. 7 or 8 may thereby be a greater than a mass of the first disk section 138A of FIG. 6. Moreover, with the inclusion of the protrusions 140 and 142, a geometry of the second disk section 138B of FIG. 7 or 8 is different than a geometry of the first disk section 138A of FIG. 6. The first disk section 138A of FIG. 6 is thereby provided with a different configuration than the second disk section 138B of FIG. 7 or 8.

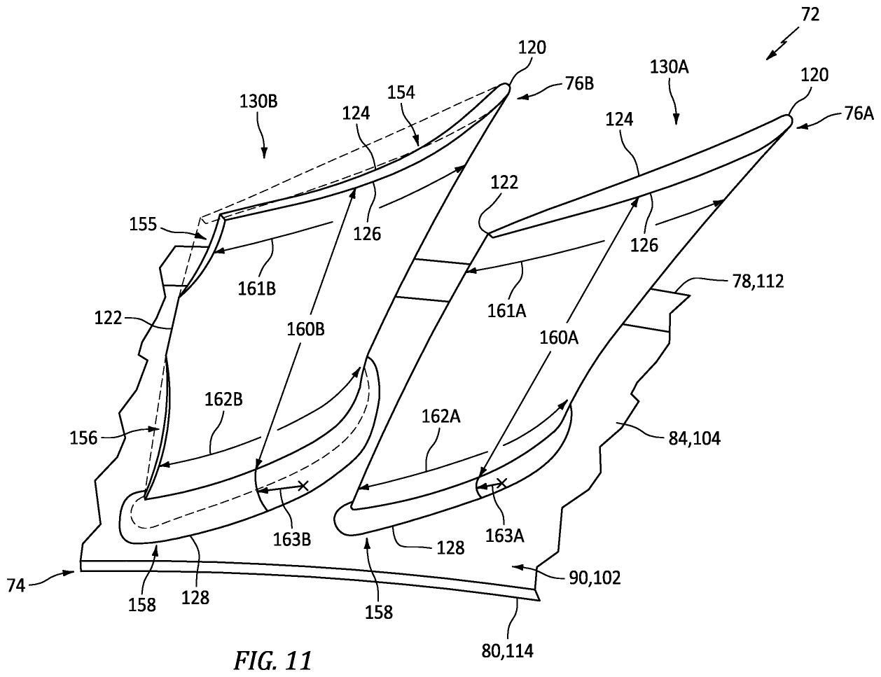

FIG. 11 illustrates various exemplary modifications, any one or more or all of which modifications may be made to each second rotor blade 76B to further (or alternatively) provide the first and the second rotor sectors 130A and 130B with different configurations. For ease of description, each first rotor blade 76A of FIG. 11 is described as having a baseline configuration, and each second rotor blade 76B of FIG. 11 is described as being modified to change its configuration relative to the first rotor blade 76A. FIG. 11 therefore includes dashed lines projected onto the second rotor blade 76B of FIG. 11 to illustrate differences between each first rotor blade 76A and each second rotor blade 76B. As shown in FIG. 11, each second rotor blade 76B includes one or more recesses (e.g., 154-156); e.g., notches, grooves or other apertures. These recesses (e.g., 154-156) are included in addition to the baseline configuration of the first rotor blade 76A of FIG. 11; thus, the first rotor blade 76A of FIG. 11 is configured without the recesses (e.g., 154-156). Moreover, each second rotor blade 76B may also or alternatively be provided with a larger blade fillet 158 at its blade base 128.

The recesses of FIG. 11 include the tip recess 154, the outer trailing edge recess 155 and the inner trailing edge recess 156. Each of these recesses 154-156 may extend laterally through the respective second rotor blade 76B between its opposing lateral sides 124 and 126. The tip recess 154 is disposed at (e.g., on, adjacent or proximate) the blade tip 116 and extends longitudinally within (or into) the respective second rotor blade 76B. The outer trailing edge recess 155 is disposed at or about the blade tip 116 and extends radially within (or into) the respective second rotor blade 76B along the trailing edge 122. This outer trailing edge recess 155 is disposed radially outboard of and may be radially spaced from the inner trailing edge recess 156. The inner trailing edge recess 156 is disposed at or about the blade base 128 and extends radially within the respective second rotor blade 76B along the trailing edge 122.

With the arrangement of FIG. 11, one or more dimensions 160A-163A of each first rotor blade 76A may be different than one or more corresponding dimensions 160B-163B of each second rotor blade 76B; e.g., measured at common reference points along the respective rotor blade 76. The span dimension 160A of the first rotor blade 76A of FIG. 11, for example, is greater than the span dimension 160B of the second rotor blade 76B of FIG. 11. The outer longitudinal dimension 161A of the first rotor blade 76A of FIG. 11 is greater than the outer longitudinal dimension 161B of the second rotor blade 76B of FIG. 11. The inner longitudinal dimension 162A of the first rotor blade 76A of FIG. 11 is greater than the inner longitudinal dimension 162B of the second rotor blade 76B of FIG. 11. The fillet dimension 163A (e.g., fillet radius) of the blade fillet 158 of the first rotor blade 76A of FIG. 11 is different (e.g., less) than the fillet dimension 163B (e.g., fillet radius) of the blade fillet 158 of the second rotor blade 76B of FIG. 11. A mass of the first rotor blade 76A of FIG. 11 may thereby be a different (e.g., greater) than a mass of the second rotor blade 76B of FIG. 11. Moreover, with the inclusion of the features 154-156 and 158, a geometry of the second rotor blade 76B of FIG. 11 is different than a geometry of the first rotor blade 76A of FIG. 11. The first rotor sector 130A of FIG. 11 is thereby provided with a different configuration than the second rotor sector 130B of FIG. 11.

While the tuned rotor sectors 130 are described above with respect to the integrally bladed rotor 72, the present disclosure is not limited thereto. It is contemplated, for example, the tuned rotor sectors 130 may also provide mistuning for a bladed rotor (e.g., the HPT rotor 53 or the LPT rotor 54) with mechanical attachments removably securing those rotor blades to its rotor disk.

While various embodiments of the present disclosure have been described, it will be apparent to those of ordinary skill in the art that many more embodiments and implementations are possible within the scope of the disclosure. For example, the present disclosure as described herein includes several aspects and embodiments that include particular features. Although these features may be described individually, it is within the scope of the present disclosure that some or all of these features may be combined with any one of the aspects and remain within the scope of the disclosure. Accordingly, the present disclosure is not to be restricted except in light of the attached claims and their equivalents.

What is claimed is:

1. An apparatus for a gas turbine engine, comprising:
a bladed rotor rotatable about an axis, the bladed rotor including a rotor disk and a plurality of rotor blades projecting radially out from the rotor disk, the bladed rotor divided into a plurality of circumferential sectors about the axis, each of the plurality of circumferential sectors having a common circumferential length about the axis, each of the plurality of circumferential sectors comprising a subset of two or more of the plurality of rotor blades, and the plurality of circumferential sectors including a first sector and a second sector;
the first sector having a first rotor configuration; and
the second sector having a second rotor configuration that is different than the first rotor configuration.

2. The apparatus of claim 1, wherein
the first sector is one of a plurality of first sectors;
the second sector is one of a plurality of second sectors; and
the plurality of second sectors are interspersed with the plurality of first sectors about the axis in a repeating pattern.

3. The apparatus of claim 1, wherein
the first sector has a first mass; and
the second sector has a second mass that is different than the first mass.

4. The apparatus of claim 1, wherein
the bladed rotor in each of the plurality of circumferential sectors has a dimension at a reference location; and
the dimension of the bladed rotor in the first sector is different than the dimension of the bladed rotor in the second sector.

5. The apparatus of claim 1, wherein
the bladed rotor in each of the plurality of circumferential sectors has a geometry; and
the geometry of the bladed rotor in the first sector is different than the geometry of the bladed rotor in the second sector.

6. The apparatus of claim 1, wherein
a section of the rotor disk defined by the first sector has a first disk configuration; and
a section of the rotor disk defined by the second sector has a second disk configuration that is different than the first disk configuration.

7. The apparatus of claim 6, wherein
the section of the rotor disk defined by the first sector has a first mass; and
the section of the rotor disk defined by the second sector has a second mass that is different than the first mass.

8. The apparatus of claim 6, wherein
the section of the rotor disk defined by the first sector has a first geometry; and
the section of the rotor disk defined by the second sector has a second geometry that is different than the first geometry.

9. The apparatus of claim 6, wherein each of the plurality of rotor blades has a common blade configuration.

10. The apparatus of claim 6, wherein
a rotor blade in the subset of the two or more of the plurality of rotor blades in the first sector has a first blade configuration; and
a rotor blade in the subset of the two or more of the plurality of rotor blades in the second sector has a second blade configuration that is different than the first blade configuration.

11. The apparatus of claim 1, wherein
each rotor blade in the subset of the two or more of the plurality of rotor blades in the first sector has a first blade configuration; and
each rotor blade in the subset of the two or more of the plurality of rotor blades in the second sector has a second blade configuration that is different than the first blade configuration.

12. The apparatus of claim 11, wherein
each rotor blade in the subset of the two or more of the plurality of rotor blades in the first sector has a first mass; and
each rotor blade in the subset of the two or more of the plurality of rotor blades in the second sector has a second mass that is different than the first mass.

13. The apparatus of claim 11, wherein
each rotor blade in the subset of the two or more of the plurality of rotor blades in the first sector has a first geometry; and
each rotor blade in the subset of the two or more of the plurality of rotor blades in the second sector has a second geometry that is different than the first geometry.

14. The apparatus of claim 1, wherein
the subset of the two or more of the plurality of rotor blades in the first sector consists of N1 number of the plurality of rotor blades;
the subset of the two or more of the plurality of rotor blades in the second sector consists of N2 number of the plurality of rotor blades; and
r is equal to the N1 number.

15. The apparatus of claim 1, wherein
the bladed rotor is divided into a number of the plurality of circumferential sectors about the axis; and
the number is an even integer between two and sixteen.

16. The apparatus of claim 1, wherein the first sector is disposed circumferentially adjacent the second sector.

17. The apparatus of claim 1, wherein the bladed rotor is configured as a turbine rotor for the gas turbine engine.

18. An apparatus for a gas turbine engine, comprising:
a bladed rotor rotatable about an axis, the bladed rotor including a rotor disk and a plurality of rotor blades arranged circumferentially around and connected to the rotor disk, the bladed rotor configured into a plurality of circumferential sectors about the axis, each of the plurality of circumferential sectors comprising a common number of the plurality of rotor blades that is greater than one, and the plurality of circumferential sectors including a first sector and a second sector;
the first sector having a first rotor mass and a first rotor geometry; and
the second sector having a second rotor mass and a second rotor geometry, at least one of
the second rotor mass different than the first rotor mass; or
the second rotor geometry different than the first rotor geometry.

19. The apparatus of claim 18, wherein
a section of the rotor disk defined by the first sector has a first disk mass and a first disk geometry;
a section of the rotor disk defined by the second sector has a second disk mass and a second disk geometry; and
at least one of the second disk mass is different than the first disk mass, or the second disk geometry is different than the first disk geometry.

20. An apparatus for a gas turbine engine, comprising:
a bladed rotor rotatable about an axis, the bladed rotor including a rotor disk and a plurality of rotor blades arranged circumferentially around and connected to the rotor disk, the bladed rotor having a plurality of circumferential sectors about the axis, each of the plurality of circumferential sectors having a common circumferential length about the axis, and the plurality of circumferential sectors including a first sector and a second sector;
a section of the rotor disk defined by the first sector having a first disk mass and a first disk geometry;
a section of the rotor disk defined by the second sector having a second disk mass and a second disk geometry; and
at least one of the second disk mass different than the first disk mass, or the second disk geometry different than the first disk geometry.
